(19) United States
(12) Patent Application Publication
(10) Pub. No.: US 2009/0080037 A1
(43) Pub. Date: Mar. 26, 2009

(54) Condenser Lens and Optical Scanning Device

(76) Inventor: Kenichi Hayashi, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/665,365

(22) PCT Filed: Oct. 18, 2005
(86) PCT No.: PCT/JP2005/019144

§ 371 Date: Dec. 8, 2008

(30) Foreign Application Priority Data
Oct. 19, 2004 (JP) 2004-304764
Dec. 20, 2004 (JP) 2004-368270

(51) Int. Cl. H04N 1/04

(52) U.S. Cl. 358/475

(57) ABSTRACT

A condenser lens including a plurality of divided lens faces which is formed in a Fresnel lens shape with grooves on a light incidence face and a light emitting face, where the divided lens faces includes a diffraction lens face on which a plurality of steps is formed.

### BACKGROUND OF THE INVENTION

1. Field of the Invention

The present invention relates to a condenser lens and an optical scanning device in which the condenser lens is used.

2. Related Art

A beam scanning device is widely used in an image forming device such as a laser printer, a digital copying machine and a facsimile or in a measuring device such as a bar-code reader and an inter-vehicle distance measuring device. In a beam scanning device which is used in an image forming device, a laser beam emitted from a laser light source is periodically deflected with a polygon mirror to repetitively perform scanning on a surface to be scanned of a photosensitive body. In a beam scanning device which is used in a measuring device, a reflected beam of a scanning light beam which is reflected by an object to be irradiated is received with a photo-detector to detect information. In this case, the reflected beam is directed to the photo-detector at an angle corresponding to the scanning angle of the polygon mirror.

Referring to FIG. 10(a), in an optical path directing to the photo-detector, a condenser lens 1′ is disposed and the reflected beam is converged through the condenser lens 1′. The condenser lens 1′ is provided with an area as wide as possible so as to guide a larger quantity of light to the photo-detector. Further, a condenser lens 1′ which is used in a bar-code reader is required to be formed in a flat face so as not to bring into contact with a commodity or the like and thin to reduce its weight.

However, when an effective area of the condenser lens 1′ is enlarged to secure a detected quantity of light, the thickness of the lens is increased and, as a result, a protruded amount of its surface is also increased. Therefore, to overcome these problems, a Fresnel lens 1″ as shown in FIG. 10(b) may be used as the condenser lens.

The Fresnel lens 1″ has a sufficiently flat surface and reduced thickness. However, in the Fresnel lens 1″, the lens face is divided into a number of portions to provide for a reduced thickness in the lens. As a result, it is difficult to manufacture a Fresnel lens 1″ in order to obtain these desired characteristics.

It should also be noted that a light beam is incident on the condenser lens with a specified range of incidence angle and thus, when an incidence angle on the condenser lens is large, a distance between the condenser lens and the photo-detector must be shortened so that a converged light beam is not displaced from an area of the photo-detector. However, when such a layout is adopted, a light condensing power of the Fresnel lens 1″ is required to further increase and thus its radius of curvature is required to be small. As a result, the number of portions of the Fresnel lens 1″ is further increased. However, in a case of the Fresnel lens 1″ having the structure as described above, as shown in FIGS. 10(d) and 10(e) where portions “A” and “B” in FIG. 10(c) are respectively enlarged, reflection and the like is occurred at a portion of a groove 20′ for the light beam L14 having a large incidence angle and thus intensity of illumination is remarkably decreased. In addition, since a tangent angle of the lens becomes large at an outer peripheral portion of the Fresnel lens 1″, as shown in FIG. 10(d), the light beam L15 cannot be incident on the lens and thus intensity of illumination is decreased.

### SUMMARY OF THE INVENTION

It is therefore an object of the present invention to provide a condenser lens which is provided with superior condensing efficiency even for large incidence angle and which is suitable for mass production.

To achieve the object, according to the present invention, there is provided a condenser lens including a plurality of divided lens faces which is formed with grooves in a Fresnel lens shape on at least one of a light incidence face and a light emitting face and the plurality of divided lens faces includes a diffraction lens face on which a plurality of steps is formed.

In accordance with the present invention, the condenser lens is provided with both of a feature as a Fresnel lens and a feature as a diffraction lens and both of refraction and diffraction are utilized. Therefore, its thickness can be easily made thinner in comparison with a conventional Fresnel lens that utilizes only refraction. Further, since the dividing number can be reduced, reflection and the like of a light beam at the grooves that occurs at a boundary portion of the divided lens faces is reduced and thus transmittance is improved.

In accordance with the present invention, it is preferable that the grooves, the divided lens faces and the steps are formed in a concentrically circular manner. According to the structure as described above, when the step is to be formed on a molding die material or lens material, it can be formed by using normal lathe machining.

In accordance with the present invention, it is preferable that, when an order of diffraction of the divided lens face in a case where the steps are not formed is 0 (zero)-order, an order of diffraction of the divided lens face which is located on a center side of the lens is smaller than an order of diffraction of the divided lens face which is located on an outer peripheral side of the lens. In this case, it may be structured that the divided lens face which is located on the center side of the lens is a refractive lens face which is not formed with the steps, and the divided lens face which is located on the outer peripheral side of the lens is the diffraction lens face which is formed with the steps. According to this structure, since a tangent angle can be reduced in the divided lens face on the outer peripheral side, a light beam even with a larger incident angle can be incident on the lens.

In accordance with the present invention, it may be structured that all of the plurality of divided lens faces are the diffraction lens faces where the steps are formed.

In the structure as described above, it may be structured that, when an order of diffraction of the divided lens face in a case where the steps are not formed is 0 (zero)-order, an order of diffraction of the divided lens face which is located on a center side of the lens is smaller than an order of diffraction of the divided lens face which is located on an outer peripheral side of the lens. According to this structure, since a tangent angle can be reduced in the divided lens face on the outer peripheral side, a light beam even with a larger incident angle can be incident on the lens. In the structure as described above, it may be structured such that, when an order of diffraction of the divided lens face in a case where the steps are not formed is 0 (zero)-order, an order of diffraction of the divided lens face which is located on a center side of the lens is larger than or equal to an order of diffraction of the divided lens face which is located on an outer peripheral side of the lens. According to this structure, since coma aberration can be restrained, a diameter of a spot can be made smaller. In the present invention, it is preferable that, when an order of diffraction of the divided lens face in a case where the steps are not formed is 0 (zero)-order, an order of diffraction of the divided lens face which is located on a center side of the lens is larger than or equal to an order of diffraction of the divided lens face which is located on an outer peripheral side of the lens. For example, the divided lens face that is located on the center side of the lens is the diffraction lens face that is formed with the steps, and the divided lens face which is located on the outer peripheral side of the lens is a refractive lens face which is not formed with the step. In this case, a structure can be realized in which the order of diffraction of the divided lens face which is located on the center side of the lens is higher than that of the divided lens face which is located on the outer peripheral side. According to this structure, since coma aberration can be restrained, a diameter of a spot can be made smaller.

In the present invention, it is preferable that the divided lens face which is located on at least innermost center side of the lens is the diffraction lens face which is formed with the steps and, in a center region of the diffraction lens face, the step is formed in a flat face. According to this structure, since the lens thickness can be made thinner, the dividing number can be reduced when a Fresnel lens structure is adopted.

In the present invention, it is preferable that refracting power and diffracting power in the diffraction lens face have positive power. As described above, since condensing power by refraction and condensing power by diffraction are added to each other, a radius of curvature of the diffraction lens face can be increased.

In the present invention, the plurality of divided lens faces are provided with, for example, different lens shapes from each other. For example, the plurality of divided lens faces are provided with different aspherical surfaces from each other. When the shapes of the respective divided lens faces are optimized as described above, a structure can be realized in which the plurality of divided lens faces are provided with a single focal point to a light beam with a specified wavelength and thus the diameter of a spot can be made smaller. Further, a design can be realized in which, when a light beam with a specified wavelength is incident at an incidence angle of 0° (zero degree), a focal point of the divided lens face which is located on the outer peripheral side of the condenser lens is positioned nearer to the condenser lens than a focal point of the divided lens face which is located on the center side of the lens. This structure provides an effective means to make the diameter of a spot smaller. In the condenser lens in accordance with the present invention, it is preferable that, when a range of an incidence angle is set to be ±θ°, a spot area at an incidence angle of θ° is 2 (two) times or less of a spot area at an incidence angle of 0 (zero)°. According to this structure, the diameter of a spot can be made smaller in the entire range of the incidence angle. Therefore, even when a multi-divided photo-detector having a high resolution power is used as a photo-detector, a spot can be formed on divided optical detection faces.

In accordance with the present invention, it is preferable that a direction of the groove which is located at a boundary region between the divided lens faces is substantially parallel to a refracting direction of a light beam. According to this structure, a light beam that is incident on the groove portion can be prevented from irradiating toward the photo-detector side. Further, since the angle of the groove is widened, machining to a die for manufacturing the lens is easy. Further, even when lens material is machined to manufacture a condenser lens, the machining is easy.

In accordance with the present invention, lens material is, for example, resin. A lens made of resin is inexpensive because, for example, it can be efficiently manufactured by die molding. Further, it is suitable for reducing weight.

In accordance with the present invention, it is preferable that the plurality of divided lens faces is formed on the light incidence face and the light emitting face is formed in a simple flat face or a simple curved surface. According to this structure, complicated machining is not required to perform on the light emitting face.

In accordance with the present invention, it is preferable that a pitch of the step is set to be 4.5 times or more of a step height which is defined as the following expression; mλ/(n−1) wherein “m” denotes order of diffraction, “λ” denotes wavelength, and “n” denotes index of refraction of the lens material. According to this structure, diffraction efficiency and transmittance can be improved.

In accordance with the present invention, it is preferable that an effective diameter forms a circular shape. According to this structure, since coma aberration occurring at corner parts when an effective lens face is formed in a rectangular shape does not occur, coma aberration can be restrained and a spot diameter can be made smaller. Therefore, even when a multi-divided photo-detector with a high degree of resolution is used as a photo-detector, a spot that is received within an area of the divided optical detection faces can be formed.

The condenser lens to which the present invention is applied may be used in an optical scanning device or the like in which a reflected light beam of a scanning light beam which is reflected by an object to be irradiated is converged on a photo-detector through the above-mentioned condensing lens.

In this case, it is preferable that a focal position of the condenser lens is located at a farther position than the photo-detector seen from the condenser lens when a light beam with a specified wavelength is incident at the incidence angle of “0°”, and a focal position of the divided lens face which is located at an outer peripheral side of the condenser lens is nearer to the photo-detector than a focal position of the divided lens face which is located at a center side of the lens. According to the structure as described above, balance of the diameter of a spot can be secured in the range of the incidence angle to the condenser lens and, as a result, the diameter of the spot on the photo-detector can be made smaller. Therefore, even when a multi-divided photo-detector with a high degree of resolution can be used as a photo-detector, a spot accepted within an area of the divided optical detection faces can be formed.

### BRIEF DESCRIPTION OF THE DRAWINGS

FIG. 1(a) is an explanatory view showing a structure of a condenser lens in accordance with a first embodiment of the present invention;

FIG. 1(b) is an enlarged explanatory view showing a center region of the structure in FIG. 1(a);

FIG. 1(c) is an enlarged explanatory view showing an outer peripheral side region of the structure in FIG. 1(a);

FIG. 1(d) is an enlarged explanatory view showing another outer peripheral side region of the structure in FIG. 1(a);

FIG. 2(a) is an explanatory view showing a structure of a condenser lens in accordance with a second embodiment of the present invention;

FIG. 2(b) is an enlarged explanatory view showing the center region of the structure in FIG. 2(a);

FIG. 2(c) is an enlarged explanatory view showing an outer peripheral side region of the structure in FIG. 2(a);

FIG. 2(d) is an enlarged explanatory view showing another outer peripheral side region of the structure in FIG. 2(a);

FIG. 3(a) is an explanatory view showing a structure of a condenser lens in accordance with a third embodiment of the present invention;

FIG. 3(b) is an enlarged explanatory view showing a part of the center region of the structure in FIG. 3(a);

FIG. 3(c) is an enlarged explanatory view showing another part of the center region of the structure in FIG. 3(a);

FIG. 3(d) is an enlarged explanatory view showing an outer peripheral side region of the structure in FIG. 3(a);

FIG. 4 is a graph showing a relationship between an incidence angle and a spot area on a photo-detector when converged on a photo-detector through the condenser lens in accordance with the third embodiment of the present invention;

FIG. 5 is an explanatory view showing a relationship between an incidence angle to the condenser lens and a spot shape on the photo-detector in accordance with the third embodiment of the present invention;

FIG. 6(a) is an explanatory view showing a structure of a condenser lens in accordance with a fourth embodiment of the present invention;

FIG. 6(b) is an enlarged explanatory view showing a part of the center region in the structure of FIG. 6(a);

FIG. 6(c) is an enlarged explanatory view showing another part of the center region of the structure in FIG. 6(a);

FIG. 6(d) is an enlarged explanatory view showing an outer peripheral side region of the structure in FIG. 6(a).

FIG. 7 is a graph showing focal positions for respective regions of the condenser lens in accordance with the fourth embodiment of the present invention;

FIG. 8 is an explanatory view showing a relationship between an incidence angle to the condenser lens and a spot shape on a photo-detector in accordance with the fourth embodiment of the present invention;

FIG. 9 is a graph showing a relationship showing an incidence angle and a spot area on the photo-detector when converged on the photo-detector through the condenser lens in accordance with the fourth embodiment of the present invention; and

FIGS. 10(a) through 10(e) are explanatory views showing a conventional condenser lens and its problems.

### DETAILED DESCRIPTION

Condenser lenses to which the present invention is applied will be described with reference to the accompanying drawings.

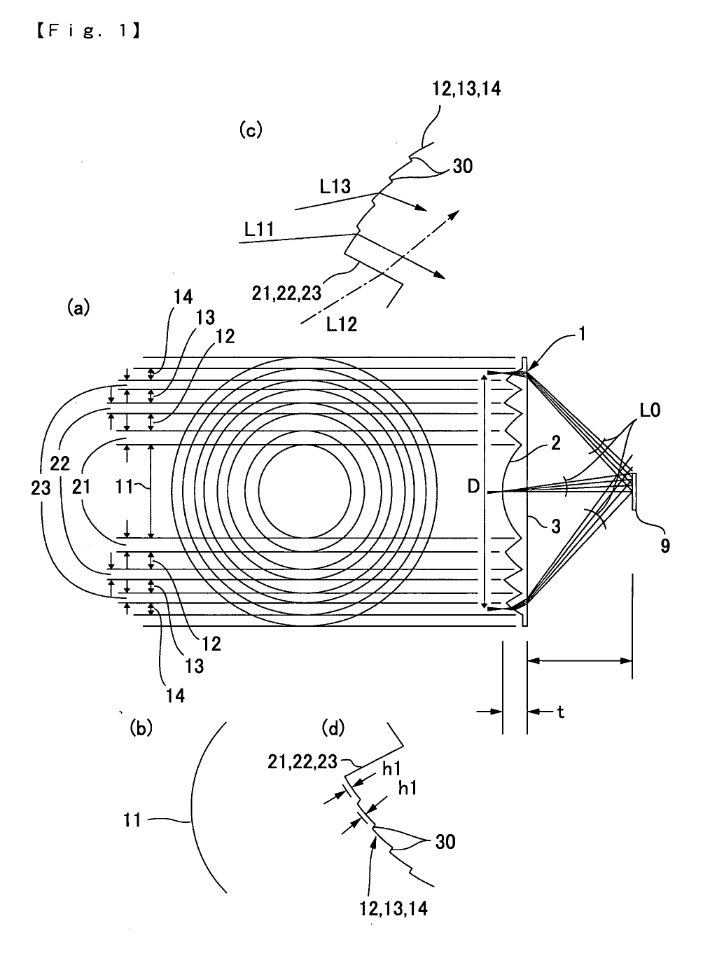

FIGS. 1(a), 1(b), 1(c) and 1(d) are respectively an explanatory view showing a structure of a condenser lens in accordance with a first embodiment of the present invention, an enlarged explanatory view showing its center region, an enlarged explanatory view showing an outer peripheral side region, and an enlarged explanatory view showing another outer peripheral side region.

A condenser lens 1 shown in FIGS. 1(a), 1(b), 1(c) and 1(d) is a lens made of resin for converging a light beam, which is a scanning light beam emitted from a beam scanning device and reflected by an object to be irradiated, on a photo-detector 9. In the condenser lens 1, a plurality of divided lens faces 11, 12, 13 and 14 in a Fresnel-lens shape is formed on a light incidence face 2 by forming concentric circular grooves 21, 22 and 23. On the other hand, a light emitting face 3 is formed in a simple flat face or a simple curved face.

The plurality of divided lens faces 11, 12, 13 and 14 includes a diffraction lens face on which a plurality of steps 30 in a concentric circular shape is formed and, in this embodiment, three divided lens faces 12, 13 and 14 are formed in the diffraction lens face.

In accordance with the first embodiment, a pitch of the step 30 is 4.5 times or more of a height “h1” of the step 30 which is defined as the following expression and wide.

h1=mλ/(n−1)
wherein “m” denotes order of diffraction, “λ” denotes wavelength, and “n” denotes index of refraction of lens material.

Further, in accordance with the first embodiment, both of refracting power and diffracting power in the plurality of divided lens faces 11, 12, 13 and 14 (diffraction lens face) are positive. The plurality of divided lens faces 11, 12, 13 and 14 are provides with, for example, different lens shapes from each other. In this embodiment, the plurality of divided lens faces 11, 12, 13 and 14 are provided with different aspherical surfaces from each other as shown by an example of their lens design data described below.

The condenser lens 1 which is structured as described above is provided with both of a feature as a Fresnel lens and a feature as a diffraction lens and, as shown by the light beam L0, an incident light beam is converged on the photo-detector 9 by utilizing both of refraction and diffraction. In this embodiment, directions of the grooves 21, 22 and 23 that are located at boundary regions between the divided lens faces 11, 12, 13 and 14 are set to be substantially parallel to a refracting direction of a light beam, for example, as shown by the light beam L11 in FIG. 1(c).

Lens design data of the condenser lens 1 are, for example, shown as follows. In the lens design data described below, the aspherical shape Z(R) of a lens surface is rotationally symmetrical and is expressed with respect to a radial coordinate “r” as follows:

Z(R)=cr²/[1+{1−(1+k)c²r²}^{1/2}]+A₄·r⁴+A₆·r⁶+··

wherein “c” denotes an inverse number of radius of curvature of “R”, “k” denotes a conic constant, A₄, A₆ . . . respectively denote aspherical surface coefficients of the fourth, the sixth, . . . . In the expression of aspherical surface coefficients, A-4, A-6, A-8 . . . respectively denote A₄, A₆, A₈ . . . and the number “m” succeeding to “E” means 1×10^{m}. The following respective design data are described in the order from the innermost periphery to an outer peripheral side.

Design Data

Divided lens face 11 (refractive lens face)

Radius (mm)=0˜8.5

Y radius of curvature (R)=11.8

Conic constant (k)=0.33427513

The fourth coefficient (A-4)=−2.57E-05

The sixth coefficient (A-6)=−2.56E-06

The eighth coefficient (A-8)=3.89E-08

The tenth coefficient (A-10)=−3.20E-10

Order of diffraction=0

Optical path difference function R̂2=0

Optical axis direction shift Δ=0

### Groove 21

Radius (mm)=8.5˜10.6

Y radius of curvature (R)=straight line

Divided lens face 12 (diffraction lens face)

Radius (mm)=10.6˜13.8

Y radius of curvature (R)=14.5106212

Conic constant (k)=−1.22252023

The fourth coefficient (A-4)=3.21E-05

The sixth coefficient (A-6)=−3.29E-08

The eighth coefficient (A-8)=3.20E-10

The tenth coefficient (A-10)=−7.70E-13

Order of diffraction=1

Optical path difference function R̂2=−2.272727273

Optical axis direction shift Δ=−4

### Groove 22

Radius (mm)=13.8-15.6

Y radius of curvature (R)=straight line

Divided lens face 13 (diffraction lens face)

Radius (mm)=15.6-18.0

Y radius of curvature (R)=15.81927282

Conic constant (k)=−1.380370538

The fourth coefficient (A-4)=2.92E-05

The sixth coefficient (A-6)=−1.31E-08

The eighth coefficient (A-8)=7.74E-11

The tenth coefficient (A-10)=−1.03E-13

Order of diffraction=1

Optical path difference function R̂2=−1.136363636

Optical axis direction shift Δ=−9

### Groove 23

Radius (mm)=18.0˜19.6

Y radius of curvature (R)=straight line

Divided lens face 14 (diffraction lens face)

Radius (mm)=19.6˜22.0

Y radius of curvature (R)=17.44361546

Conic constant (k)=−1.31833077

The fourth coefficient (A-4)=1.99E-05

The sixth coefficient (A-6)=2.03E-09

The eighth coefficient (A-8)=1.28E-11

The tenth coefficient (A-10)=−1.30E-14

Order of diffraction=1

Optical path difference function R̂2=−1.136363636

Optical axis direction shift Δ=−13

The condenser lens 1 which is structured as described above is provided with both of a feature as a Fresnel lens and a feature as a diffraction lens and an incident light beam is converged on the photo-detector 9 by using both of refraction and diffraction. Therefore, the lens thickness “t” can be made thinner, for example, to 4 mm in comparison with a conventional Fresnel lens which utilizes only refraction. Further, since light condensing ability is high, a distance between the condenser lens 1 and the photo-detector 9 can be shortened to 18 mm.

Further, since diffraction is used together, a dividing number may be reduced, for example, to 4. Therefore, reflection and the like of a light beam at the grooves 21, 22 and 23 which occurs at a boundary portion of the divided lens faces 11, 12, 13 and 14 is reduced by the reduced number of the grooves 21, 22 and 23 and thus transmittance is improved.

In addition, both of refracting power and diffracting power in the plurality of divided lens faces 11, 12, 13 and 14 (diffraction lens face) are provided with positive power and thus radius of curvature of each of the respective divided lens faces 11, 12, 13 and 14 can be increased. In addition, the plurality of divided lens faces 11, 12, 13 and 14 are provided with aspherical surfaces which are different from each other and thus each of the plurality of divided lens faces 11, 12, 13 and 14 is provided with a single focal point to a light beam with a specified wavelength. Therefore, a diameter of a spot on the photo-detector 9 can be made smaller.

Further, when an order of diffraction of the divided lens face 11 where the step 30 is not formed is 0 (zero)-order, the order of diffraction of the divided lens face 11 located on a center side of the lens is O-order and the order of diffraction of the divided lens faces 12, 13 and 14 (diffraction lens face) located on an outer peripheral side of the lens is 1st-order. Therefore, the order of diffraction of the divided lens face 11 located on the center side of the lens is smaller than that of the divided lens faces 12, 13 and 14 located on the outer peripheral side of the lens. As a result, a tangent angle can be made smaller even at the divided lens faces 12, 13 and 14 on the outer peripheral side and thus, as shown by the light beam L13 in FIG. 1(c), a light beam can be incident on the condenser lens 1 even when an incident angle of the light beam is large.

Further, since directions of the grooves 21, 22 and 23 are substantially parallel to the refracting direction of a light beam, as shown by the light beam L12 in FIG. 1(c), a light beam incident on the grooves 21, 22 and 23 can be prevented from irradiating to the photo-detector side. Further, since angles of the grooves 21, 22, 23 are broad, machining to a die for manufacturing the lens is easy.

Further, the light emitting face 3 is formed in a simple flat face or a simple curved face and thus complicated machining is not required to form the light emitting face 3.

In addition, in this embodiment, since the effective diameter “D” is in a circular shape, coma aberration occurring at corner parts when an effective lens face is in a rectangular shape does not occur. Therefore, coma aberration can be restrained in comparison with the case where the effective face is formed in a rectangular shape and thus a spot diameter can be made smaller.

In addition, a pitch of the step 30 is 4.5 times or more of the height “h1” of the step 30 and thus the number of the step 30 is reduced. Therefore, diffraction efficiency and transmittance can be improved.

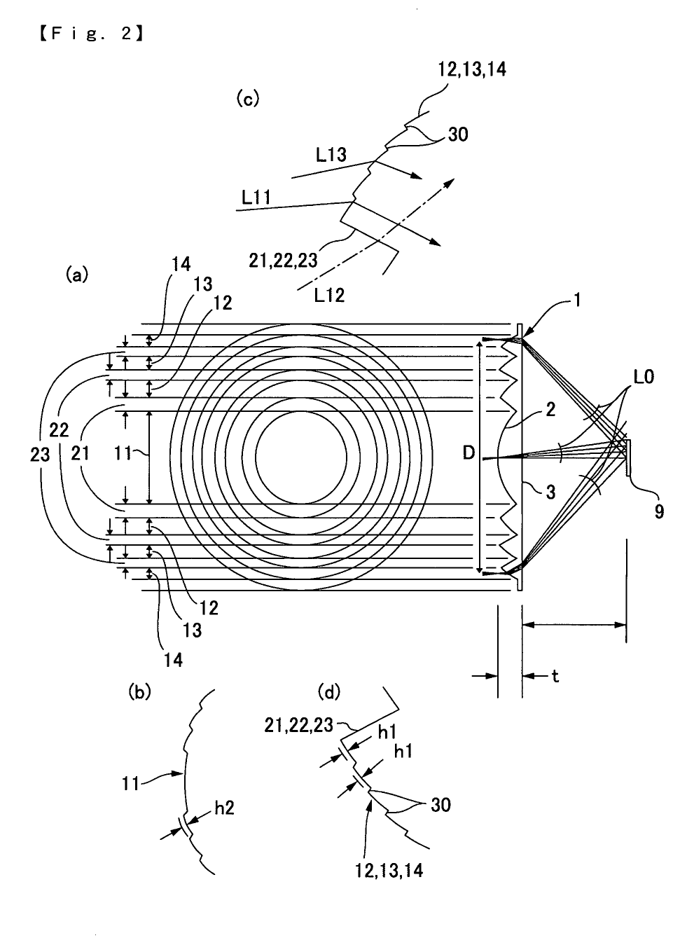

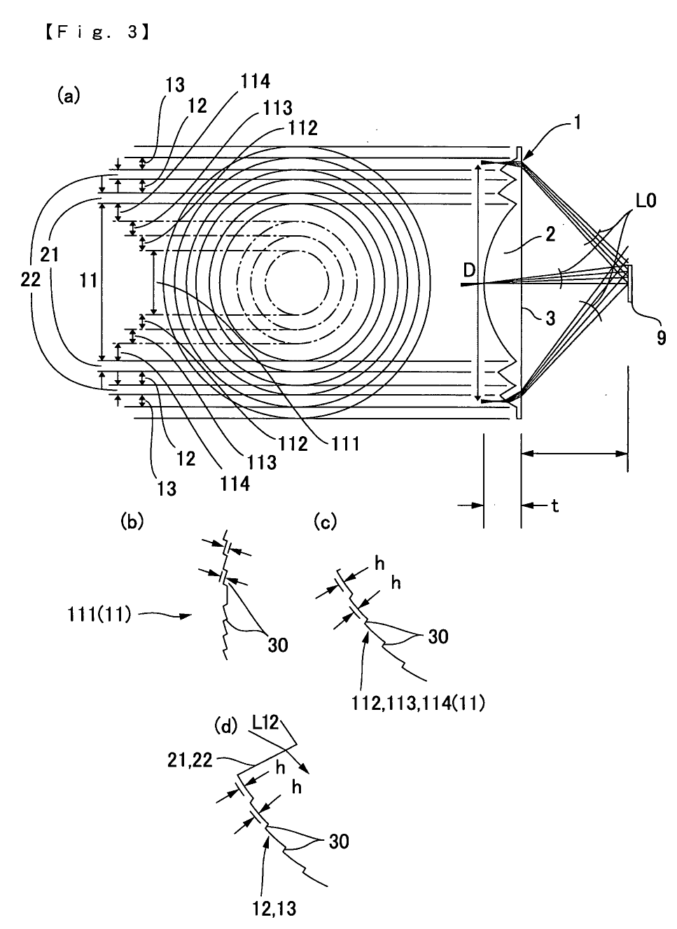

FIG. 2(a), 2(b), 2(c) and 2(d) are respectively an explanatory view showing a structure of a condenser lens in accordance with a second embodiment of the present invention, an enlarged explanatory view showing its center region, an enlarged explanatory view showing an outer peripheral side region, and an enlarged explanatory view showing another outer peripheral side region. A basic structure of the condenser lens in the second embodiment is similar to that in the first embodiment and thus the same notational symbols are used in portions corresponding to those in the first embodiment and their detailed description is omitted.

A condenser lens 1 shown in FIGS. 2(a), 2(b), 2(c) and 2(d) is, similarly to the first embodiment, a lens made of resin for converging a light beam, which is a scanning light beam emitted from a beam scanning device and reflected by an object to be irradiated, on a photo-detector 9. In the condenser lens 1, a plurality of divided lens faces 11, 12, 13 and 14 in a Fresnel-lens shape is formed on a light incidence face 2 by forming concentric circular grooves 21, 22 and 23. On the other hand, a light emitting face 3 is formed in a simple flat face or a simple curved surface.

In the second embodiment, all of a plurality of divided lens faces 11, 12, 13 and 14 are formed in a diffraction lens face where a plurality of steps 30 is formed in a concentrically circular shape.

In this embodiment, a pitch of the step 30 is 4.5 times or more of heights “h1” and “h2” of the step 30 which are defined as the following expressions;

h1=mA/(n−1)

h2=mA/(n−1)

wherein “m” denotes order of diffraction, “λ” denotes wavelength, and “n” denotes index of refraction of the lens material.

Further, in this embodiment, both of refracting power and diffracting power in the plurality of divided lens faces 11, 12, 13 and 14 (diffraction lens face) have positive power.

Further, the plurality of divided lens faces 11, 12, 13 and 14 are provides with, for example, different lens shapes from each other. In this embodiment, the plurality of divided lens faces 11, 12, 13 and 14 are provided with different aspherical surfaces from each other as shown by an example of lens design data described below.

The condenser lens 1 which is structured as described above is provided with both of a feature as a Fresnel lens and a feature as a diffraction lens and, as shown by the light beam L0, an incident light beam is converged on the photo-detector 9 by using both of refraction and diffraction. In this embodiment, directions of the grooves 21, 22 and 23 that are located at boundary regions between the divided lens faces 11, 12, 13 and 14 are set to be substantially parallel to a refracting direction of a light beam, for example, as shown by the light beam L11 in FIG. 1(c).

Lens design data of the condenser lens 1 in the second embodiment are, for example, shown as follows.

Divided lens face 11 (diffraction lens face)

Radius (mm)=0˜9.5

Y radius of curvature (R)=12.44212513

Conic constant (k)=−0.57600452

The fourth coefficient (A-4)=1.7459E-05

The sixth coefficient (A-6)=−3.4237E-07

The eighth coefficient (A-8)=4.50666E-09

The tenth coefficient (A-10)=−2E-11

Order of diffraction=2

Optical path difference function R̂2=−2.840909091

Optical axis direction shift Δ=0

### Groove 21

Radius (mm)=9.5˜10.8

Y radius of curvature (R)=straight line

Divided lens face 12 (diffraction lens face)

Radius (mm)=10.8˜14.4

Y radius of curvature (R)=14.20502747

Conic constant (k)=−1.144824178

The fourth coefficient (A-4)=3.45202E-05

The sixth coefficient (A-6)=−1.16675E-08

The eighth coefficient (A-8)=1.39156E-10

The tenth coefficient (A-10)=−2.10401E-13

Order of diffraction=2

Optical path difference function RA2=−2.272727273

Optical axis direction shift Δ=−4.6

### Groove 22

Radius (mm)=14.4˜15.8

Y radius of curvature (R)=straight line

Divided lens face 13 (diffraction lens face)

Radius (mm)=15.8-18.4

Y radius of curvature (R)=15.26028785

Conic constant (k)=−1.771677837

The fourth coefficient (A-4)=4.79866E-05

The sixth coefficient (A-6)=−3.96942E-08

The eighth coefficient (A-8)=1.31887E-10

The tenth coefficient (A-10)=−1.45567E-13

Order of diffraction=2

Optical path difference function R̂2=−1.136363636

Optical axis direction shift Δ=−10

### Groove 23

Radius (mm)=18.4-20.0

Y radius of curvature (R)=straight line

Divided lens face 13 (diffraction lens face)

Radius (mm)=20.0˜22.0

Y radius of curvature (R)=17.64423345

Conic constant (k)=−1.268024731

The fourth coefficient (A-4)=2.09441E-05

The sixth coefficient (A-6)=5.02943E-09

The eighth coefficient (A-8)=1.16161E-11

The tenth coefficient (A-10)=−1.3599E-14

Order of diffraction=3

Optical path difference function RA2=−1.136363636

Optical axis direction shift Δ=−13

The condenser lens 1 which is structured as described above is provided with both of a feature as a Fresnel lens and a feature as a diffraction lens and thus an incident light beam is converged on the photo-detector 9 by using both of refraction and diffraction. Therefore, the lens thickness “t” can be made thinner, for example, to 5 mm in comparison with a conventional Fresnel lens which utilizes only refraction. Further, since light condensing ability is high, a distance between the condenser lens 1 and the photo-detector 9 can be shortened to 14.5 mm and thus an influence of reflection and the like to the photo-detector 9 can be reduced by the shortened distance as described above.

Further, since diffraction is used together, a dividing number may be reduced, for example, to 4. Therefore, reflection and the like of a light beam in the grooves 21, 22 and 23 which occurs at a boundary portion of the divided lens faces 11, 12, 13 and 14 is reduced by the reduced number of the grooves 21, 22 and 23, and thus transmittance is improved.

Further, in the second embodiment, both of refracting power and diffracting power in the divided lens faces 11, 12, 13 and 14 (diffraction lens face) have positive power and thus radius of curvature of each of the respective divided lens faces 11, 12, 13 and 14 can be increased.

Further, the plurality of divided lens faces 11, 12, 13 and 14 are provided with aspherical surfaces which are different from each other and thus each of the plurality of divided lens faces 11, 12, 13 and 14 is provided with a single focal point to a light beam with a specified wavelength. Therefore, a diameter of a spot on the photo-detector 9 can be made smaller.

Further, the order of diffraction of the divided lens faces 11, 12 and 13 (diffraction lens face) located on a center side of the lens is 2nd-order and the order of diffraction of the divided lens face 14 (diffraction lens face) located on an outer peripheral side of the lens is 3rd-order. Therefore, the order of diffraction of the divided lens faces 11, 12 and 13 located on the center side of the lens is smaller than that of the divided lens face 14 located on the outer peripheral side of the lens. Therefore, a tangent angle can be made small even at the divided lens face 14 on the outer peripheral side and thus, as shown by the light beam L13 in FIG. 2(c), a light beam can be incident on the condenser lens 1 even when an incident angle of the light beam is large.

Further, since directions of the grooves 21, 22 and 23 are substantially parallel to the refracting direction of a light beam, as shown by the light beam L12 in FIG. 2(c), a light beam incident on the grooves 21, 22 and 23 can be prevented from irradiating to the photo-detector side. Further, since angles of the grooves 21, 22, 23 are broad, machining to a die for manufacturing a lens is easy.

Further, the light emitting face 3 is formed in a simple flat face or a simple curved face and thus complicated machining is not required to form the light emitting face 3.

In addition, in this embodiment, since the effective diameter “D” is in a circular shape of about 30Φ, coma aberration occurring at corner parts when an effective lens face is formed in a rectangular shape does not occur. Therefore, coma aberration can be restrained in comparison with the case where the effective face is formed in a rectangular shape and thus a spot diameter can be made smaller.

In addition, a pitch of the step 30 is 4.5 times or more of the heights “h1” and “h2” of the step 30 and thus the number of the steps 30 is reduced. Therefore, diffraction efficiency and transmittance can be improved.

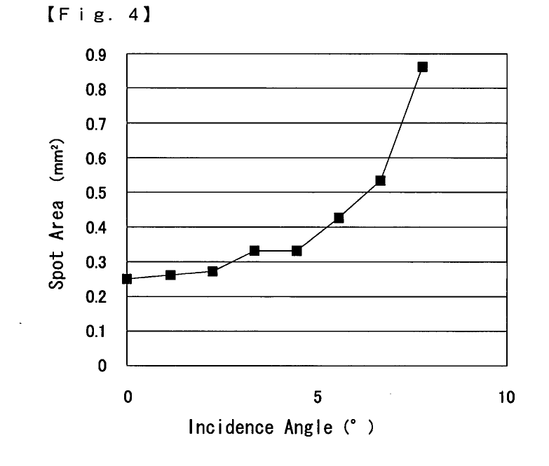

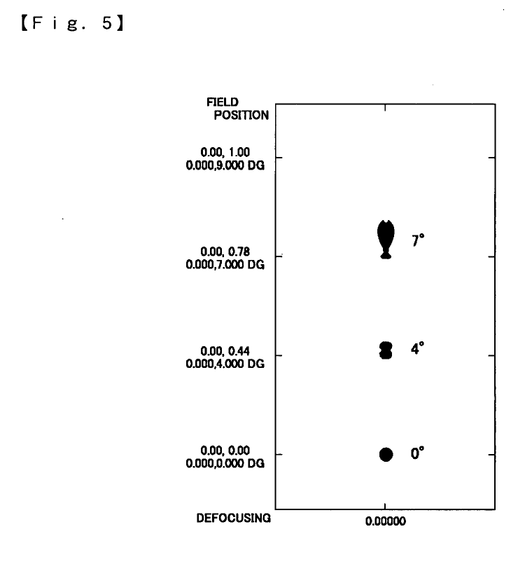

FIGS. 3(a), 3(b), 3(c) and 3(d) are respectively an explanatory view showing a structure of a condenser lens in accordance with a third embodiment of the present invention, an enlarged explanatory view showing a part of its center region, an enlarged explanatory view showing another part of the center region, and an enlarged explanatory view showing an outer peripheral side region. FIG. 4 is a graph showing a relationship between an incidence angle and a spot area in a photo-detector when converged on the photo-detector through the condenser lens in accordance with the third embodiment of the present invention. FIG. 5 is an explanatory view showing a relationship between an incidence angle to the condenser lens and a spot shape in the photo-detector in accordance with the third embodiment of the present invention.

The condenser lens 1 shown in FIGS. 3(a), 3(b), 3(c) and 3(d) is, similarly to the first embodiment, a lens made of resin for converging a light beam, which is a scanning light beam emitted from a beam scanning device and reflected by an object to be irradiated, on a photo-detector 9. In the condenser lens 1, a plurality of divided lens faces 11, 12 and 13 in a Fresnel-lens shape is formed on a light incidence face 2 by forming with concentric circular grooves 21 and 22. On the other hand, a light emitting face 3 is formed in a simple flat face or a simple curved surface. In this embodiment, directions of the grooves 21 and 22 which are located at boundary regions between the divided lens faces 11, 12 and 13 are, similarly to the first embodiment, set to be substantially parallel to the refracting direction of a light beam.

Further, as shown by an example of lens design data described below, the plurality of divided lens faces 11, 12 and 13 are provided with different lens shapes from each other and the plurality of divided lens faces 11, 12 and 13 are provided with different aspherical surfaces from each other as a whole.

In addition, in this embodiment, the center lens surface 11 is divided into four circular zone regions 111, 112, 113 and 114, and each of the circular zone regions 111, 112, 113 and 114 is formed in a diffraction lens face where a plurality of steps 30 is formed in a concentrically circular manner. The innermost circular zone region 111 is formed with a flat face on which the steps 30 are formed, and other three circular zone regions 112, 113 and 114 are formed with a specified aspherical surface on which the steps 30 are formed, and the circular zone regions 111, 112, 113 and 114 are formed with diffraction gratings with different optical path difference functions. Further, the divided lens faces 12 and 13 on an outer peripheral side are also formed in a diffraction lens face having the steps 30.

In the third embodiment, a pitch of the step 30 is 4.5 times or more of a height “h” of the step 30, which is defined as the following expression;

h=mλ/(n−1)

wherein “m” denotes order of diffraction, “A” denotes wavelength, and “n” denotes index of refraction of the lens material. Further, both of refracting power and diffracting power in the plurality of divided lens faces 11, 12 and 13 (diffraction lens face) have positive power.

Lens design data of the condenser lens 1 in this embodiment are, for example, shown as follows.

Divided lens face 11 (diffraction lens face)

Circular zone region 111
Radius (mm)=0-2.0
Y radius of curvature (R)=infinity
Conic constant (k)=0
The fourth coefficient (A-4)=0
The sixth coefficient (A-6)=0
The eighth coefficient (A-8)=0
The tenth coefficient (A-10)=0
Order of diffraction=3
Optical path difference function RA2=−10.473285
Optical path difference function RA4=0.008546799
Optical axis direction shift A=0
   Circular zone region 112

Radius (mm)=2.0-5.0

Y radius of curvature (R)=18.34390013

Conic constant (k)=1.736310589

The fourth coefficient (A-4)=−5.26E-05

The sixth coefficient (A-6)=0.00E+00

The eighth coefficient (A-8)=0.00E+00

The tenth coefficient (A-10)=0.00 E+00

Order of diffraction=3

Optical path difference function RA2=−4.54545455

Optical axis direction shift Δ=−0.11

Circular zone region 113

Radius (mm)=5.0-7.5

Y radius of curvature (R)=15.481-48913

Conic constant (k)=0.093120451

The fourth coefficient (A-4)=−2.36E-05

The sixth coefficient (A-6)=0.00 E+00

The eighth coefficient (A-8)=0.00E+00

The tenth coefficient (A-10)=0.00E+00

Order of diffraction=3

Optical path difference function RA2=−3.40909091

Optical axis direction shift Δ=−0.22

Circular zone region 114

Radius (mm)=7.5˜9.0

Y radius of curvature (R)=14.22517578

Conic constant (k)=−8.19-05

The fourth coefficient (A-4)=−4.07E-05

The sixth coefficient (A-6)=4.90E-07

The eighth coefficient (A-8)=−2.84E-09

The tenth coefficient (A-10)=−7.57E-11

The twelfth coefficient (A-12)=6.40E-13

Order of diffraction=3

Optical path difference function R̂2=−2.84090909

Optical axis direction shift Δ=−0.39

### Groove 21

Radius (mm)=9.0˜9.6

Y radius of curvature (R)=straight line

Divided lens face 12 (diffraction lens face)

Radius (mm)=9.6˜12.0

Y radius of curvature (R)=14.92917046

Conic constant (k)=−0.63751156

The fourth coefficient (A-4)=0.00E+00

The sixth coefficient (A-6)=7.31 E-08

The eighth coefficient (A-8)=−1.86E-10

The tenth coefficient (A-10)=0.00E+00

Order of diffraction=3

Optical path difference function R̂2=−2.27272727

Optical axis direction shift Δ=−3.5

### Groove 22

Radius (mm)=12.0-12.5

Y radius of curvature (R)=straight line

Divided lens face 13 (diffraction lens face)

Radius (mm)=12.5-15.0

Y radius of curvature (R)=15.22547424

Conic constant (k)=−0.73199284

The fourth coefficient (A-4)=1.30E-05

The sixth coefficient (A-6)=5.61E-09

The eighth coefficient (A-8)=0.00E+00

The tenth coefficient (A-10)=0.00E+00

Order of diffraction=3

Optical path difference function R̂2=−1.70454545

Optical axis direction shift Δ=−5.8

The condenser lens 1 which is structured as described above is provided with both of a feature as a Fresnel lens and a feature as a diffraction lens and thus an incident light beam is converged on the photo-detector 9 by using both of refraction and diffraction. Therefore, the lens thickness “t” can be made thinner in comparison with a conventional Fresnel lens which utilizes only refraction. Further, since light condensing ability is high, a distance between the condenser lens 1 and the photo-detector 9 can be shortened to 14.5 mm and thus an influence of reflection and the like to the photo-detector 9 can be reduced by the shortened distance as described above.

In the third embodiment, a relationship between an incidence angle and a spot area in the photo-detector when converged on the photo-detector 9 by the condenser lens 1 is shown in FIG. 4. In other words, results of the incident angle and the longitudinal dimension and the transversal dimension of the spot are shown as follows.

| Incident | Transversal | Longitudinal | Area |
|---|---|---|---|
| angle (°) | dimension (mm) | dimension (mm) | (mm²) |
| 0 | 0.5 | 0.5 | 0.25 |
| 1 | 0.5 | 0.5 | 0.25 |
| 3 | 0.5 | 0.5 | 0.25 |
| 4 | 0.5 | 0.6 | 0.30 |
| 5 | 0.5 | 0.8 | 0.40 |
| 6 | 0.5 | 1.0 | 0.50 |
| 7 | 0.7 | 1.2 | 0.84 |

Further, a relationship between an incidence angle to the condenser lens 1 and a spot shape on the photo-detector 9 is shown in FIG. 5. As shown in FIGS. 4 and 5, in the third embodiment, a diameter of the spot is smaller in a range of an incident angle of ±6°, which satisfies 0. 5 mm² that is a tolerance of a spot area when a multi-divided photo-detector having a high resolution power is used. Therefore, even when a multi-divided photo-detector having a high resolution power is used as the photo-detector 9, a spot can be formed on the divided optical detection faces.

Further, since diffraction and refraction are used together, and the steps 30 are formed in a flat face in the innermost circular zone region 111. Therefore, since the lens thickness “t” can be made thinner, the dividing number can be reduced to 3 in a case that a Fresnel lens structure is adopted. Accordingly, reflection and the like of a light beam in the grooves 21 and 22 occurring at boundary portions of the divided lens faces 11, 12 and 13 is reduced by the reduced number of the grooves 21 and 22, and transmittance is improved.

Further, in the third embodiment, both of refracting power and diffracting power in the divided lens faces 11, 12 and 13 (diffraction lens face) have positive power and condensing power is enhanced by utilizing 3-rd order of diffraction, and thus radius of curvature of each of the respective divided lens faces 11, 12 and 13 can be increased. Further, the plurality of divided lens faces 11, 12 and 13 are provided with different aspherical surfaces from each other. In addition, the plurality of divided lens faces 11, 12 and 13 are designed in which, with respect to a light beam with a specified wavelength at the incidence angle “0°”, the focal points of the divided lens face 12 and the divided lens face 13 that are located on the outer peripheral side of the lens are positioned at a nearer side of the condenser lens 1 than that of the divided lens face 11 that is located at the center side of the lens. Therefore, a diameter of a spot on the photo-detector 9 can be reduced.

Further, since directions of the grooves 21 and 22 are substantially parallel to a refracting direction of a light beam, as shown by the light beam L12 in FIG. 1(c) and FIG. 2(c), light beams which are incident on the grooves 21 and 22 are prevented from irradiating toward the photo-detector side. Further, since angles of the grooves 21 and 22 are broad, machining to a die for manufacturing a lens is easy.

Further, the light emitting face 3 is formed in a simple flat face or a simple curved face and thus complicated machining is not required to form the light emitting face 3.

In addition, in this embodiment, since the effective diameter “D” is in a circular shape of about 30Φ, coma aberration occurring at corner parts when an effective lens face is in a rectangular shape does not occur. Therefore, coma aberration can be restrained in comparison with the case where the effective face is in a rectangular shape and thus a spot diameter can be made smaller.

In addition, the minimum pitch of the step 30 is about 20 μm to the height “h” of the step 30 of about 4 μm, and a pitch of the step 30 is set to be 4.5 times or more of the height “h” of the step 30 and thus diffraction efficiency is high and transmittance can be improved.

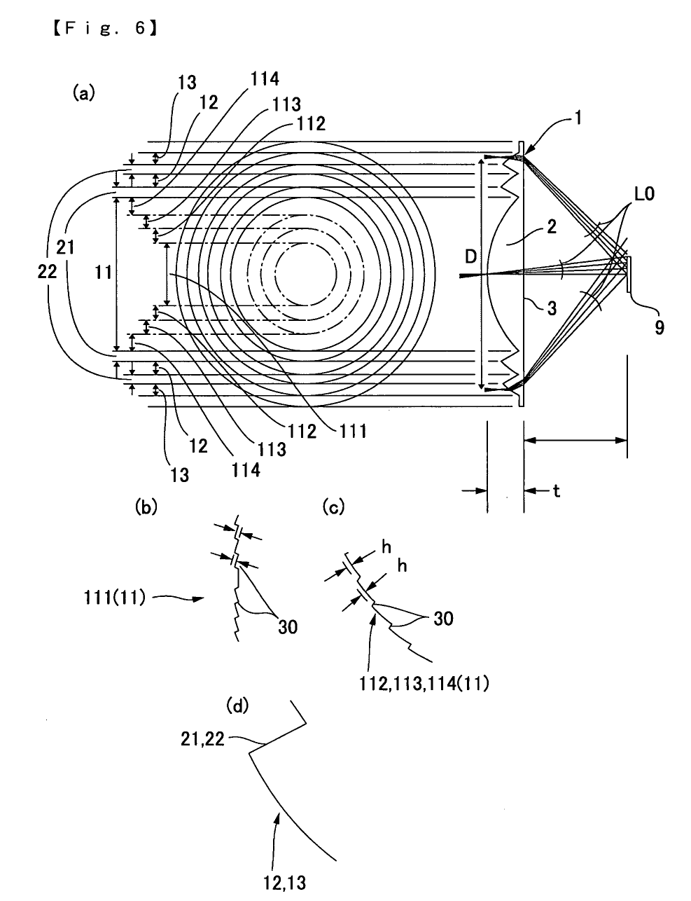

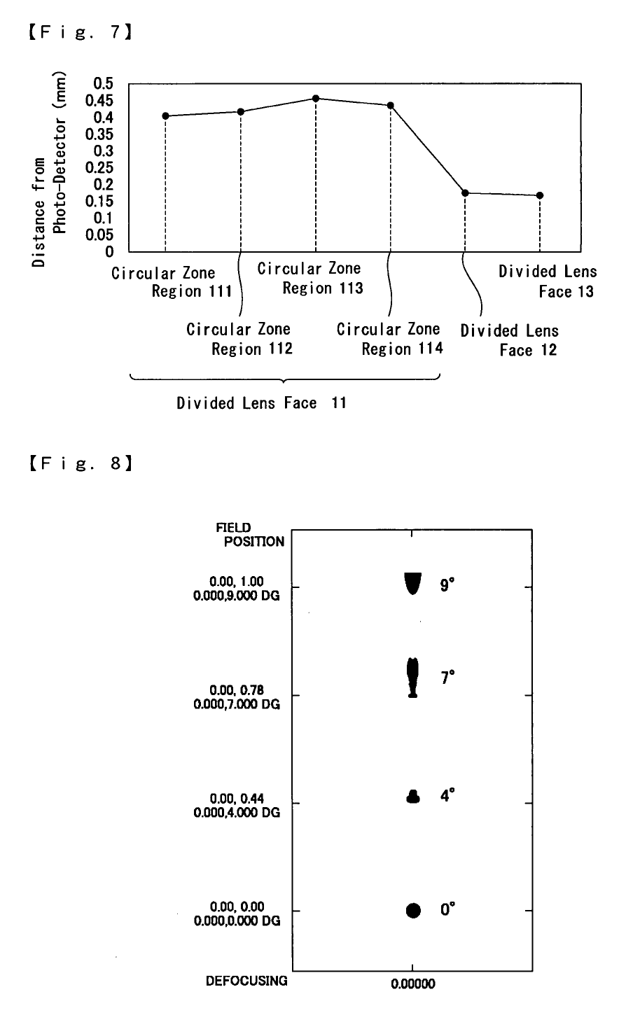

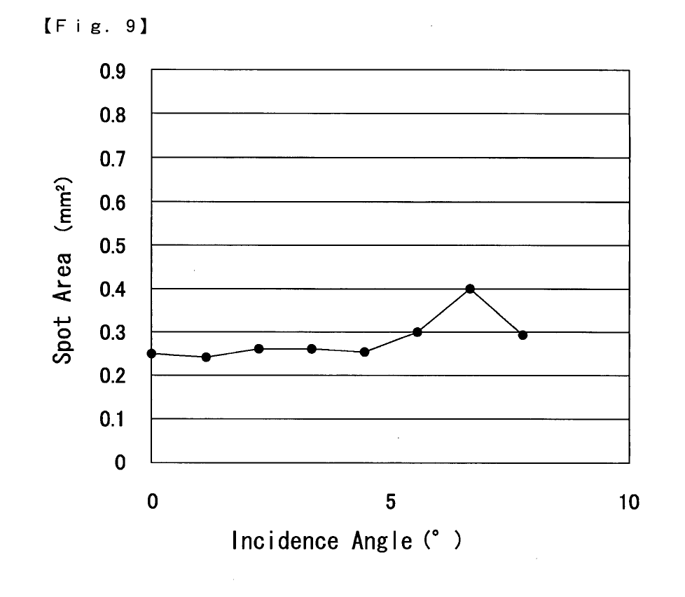

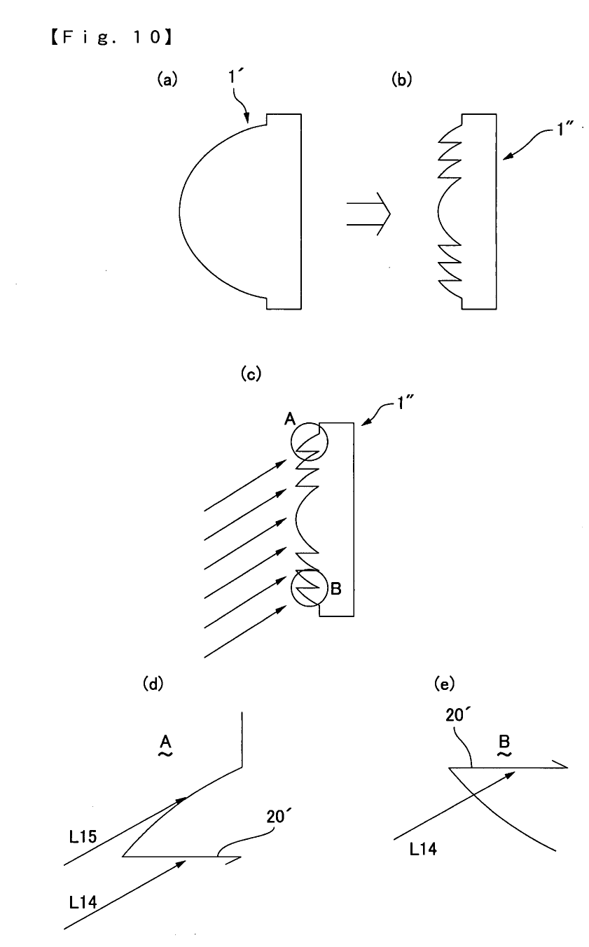

FIG. 6(a), 6(b), 6(c) and 6(d) are respectively an explanatory view showing a structure of a condenser lens in accordance with a fourth embodiment of the present invention, an enlarged explanatory view showing a part of its center region, an enlarged explanatory view showing another part of the center region, and an enlarged explanatory view showing an outer peripheral side region. FIG. 7 is a graph showing focal positions for respective regions of the condenser lens in accordance with this embodiment. FIG. 8 is an explanatory view showing a relationship between an incidence angle to the condenser lens in accordance with this embodiment and a spot shape on a photo-detector. FIG. 9 is a graph showing a relationship showing an incidence angle and a spot area on the photo-detector when converged on the photo-detector by the condenser lens in accordance with this embodiment.

A condenser lens 1 shown in FIGS. 6(a), 6(b), 6(c) and 6(d) is, similarly to the first embodiment, a lens made of resin for converging a light beam, which is a scanning light beam emitted from a beam scanning device and reflected by an object to be irradiated, on a photo-detector 9. In the condenser lens 1, divided lens faces 11, 12 and 13 in a Fresnel-lens shape is formed on a light incidence face 2 by forming concentric circular grooves 21 and 22. On the other hand, a light emitting face 3 is formed in a simple flat face or a simple curved surface. In this embodiment, directions of the grooves 21 and 22 which are located at boundary regions between the divided lens faces 11, 12 and 13 are, similarly to the first embodiment, set to be substantially parallel to a refracting direction of a light beam.

Further, as shown by an example of lens design data described below, the plurality of divided lens faces 11, 12 and 13 are provided with different lens shapes from each other and the plurality of divided lens faces 11, 12 and 13 are provided with different aspherical surfaces from each other as a whole.

In addition, in this embodiment, the center lens surface 11 is divided into four circular zone regions 111, 112, 113 and 114, and each of the circular zone regions 111, 112, 113 and 114 is formed in a diffraction lens face where a plurality of steps 30 is formed in a concentrically circular manner. The innermost circular zone region 111 is formed in a flat face, and other three circular zone regions 112, 113 and 114 are formed in a specified aspherical surface and the circular zone regions 111, 112, 113 and 114 are formed with diffraction gratings having different optical path difference functions. Further, both of refracting power and diffracting power in the divided lens face 11 have a positive power. In this embodiment, a pitch of the step 30 is 4.5 times or more of a height “h” of the step 30, which is defined as the following expression;

h=mλ/(n−1)
wherein “m” denotes order of diffraction, “A” denotes wavelength, and “n” denotes index of refraction of the lens material.
   This structure is similar to the third embodiment.

On the other hand, in this embodiment which is different from the third embodiment, the divided lens faces 12 and 13 on an outer peripheral side are formed in a refractive lens face which is not formed with a step 30.

Lens design data of the condenser lens 1 in the fourth embodiment are, for example, shown as follows.

Divided lens face 11 (diffraction lens face)

Circular zone region 111
Radius (mm)=0-2.0
Y radius of curvature (R)=infinity
Conic constant (k)=0
The fourth coefficient (A-4)=0
The sixth coefficient (A-6)=0
The eighth coefficient (A-8) 0
The tenth coefficient (A-10)=0
Order of diffraction=3
Optical path difference function R̂2=−10.473285
Optical path difference function R̂4=0.008546799
Optical axis direction shift Δ=0
   Circular zone region 112

Radius (mm)=2.0-5.0

Y radius of curvature (R)=18.34390013

Conic constant (k)=1.736310589

The fourth coefficient (A-4)=−5.26E-05

The sixth coefficient (A-6)=0.00E+00

The eighth coefficient (A-8)=0.00E+00

The tenth coefficient (A-10)=0.00E+00

Order of diffraction=3

Optical path difference function R̂2=−4.54545455

Optical axis direction shift Δ=−0.11

Circular zone region 113

Radius (mm)=5.0˜7.5 Y radius of curvature (R)=15.48148913

Conic constant (k)=0.093120451

The fourth coefficient (A-4)=−2.36E-05

The sixth coefficient (A-6)=0.00E+00

The eighth coefficient (A-8)=0.00E+00

The tenth coefficient (A-10)=0.00E+00

Order of diffraction=3

Optical path difference function R̂2=−3.40909091

Optical axis direction shift □=−0.22

Circular zone region 114

Radius (mm)=7.5˜9.0

Y radius of curvature (R)=14.22517578

Conic constant (k)=−8.19E-05

The fourth coefficient (A-4)=−4.07E-05

The sixth coefficient (A-6)=4.90E-07

The eighth coefficient (A-8)=−2.84E-09

The tenth coefficient (A-10)=−7.57E-11

The twelfth coefficient (A-12)=6.40E-13

Order of diffraction=3

Optical path difference function R̂2=−2.84090909

Optical axis direction shift Δ=−0.39

### Groove 21

Radius (mm)=9.0˜9.6

Y radius of curvature (R)=straight line

Divided lens face 12 (refractive lens face)

Radius (mm)=9.6-12.0

Y radius of curvature (R)=11.7642015

Conic constant (k)=−0.63751156

The fourth coefficient (A-4)=0.00E+00

The sixth coefficient (A-6)=1.03E-07

The eighth coefficient (A-8)=−4.34E-10

The tenth coefficient (A-10)=0.00E+00

Optical axis direction shift Δ=−4.4

### Groove 22

Radius (mm)=12.0˜12.8

Y radius of curvature (R)=straight line

Divided lens face 13 (refractive lens face)

Radius (mm)=12.8-15.0

Y radius of curvature (R)=12.98095761

Conic constant (k)=−0.73662318

The fourth coefficient (A-4)=1.55E-05

The sixth coefficient (A-6)=8.38E-09

The eighth coefficient (A-8)=0.00E+00

The tenth coefficient (A-10)=0.00 E+00

The tenth coefficient (A-10)=0.00E+00

Optical axis direction shift Δ=−7.5

In the condenser lens 1 as structured above, focal positions of a center lens surface 11 (circular zone regions 111, 112, 113 and 114) and refractive lens faces on the outer peripheral side (divided lens faces 12 and 13) are, as shown in FIG. 7, set in which, when a light beam with a specified wavelength is incident at the incidence angle “0°”, a focal position of the condenser lens 1 is located at a farther position than the photo-detector 9 seen from the condenser lens 1 and, in which focal positions of the divided lens faces 12 and 13 which are located at the outer peripheral side in the condenser lens 1 are nearer to the photo-detector 9 than that of the divided lens face 11 (circular zone regions 111, 112, 113 and 114) which is located at the center side. In other words, distances of the focal positions of the respective regions from the photo-detector 9 are set to be as follows.

| | |
|---|---|
| Divided lens face 11 | Distance of focal position from |
| | photo-detector 9 |
| Circular zone region 111 | 0.41 mm |
| Circular zone region 112 | 0.43 mm |
| Circular zone region 113 | 0.47 mm |
| Circular zone region 114 | 0.45 mm |
| Divided lens face 12 | 0.21 mm |
| Divided lens face 13 | 0.19 mm |

The condenser lens 1 which is structured as described above is provided with both of a feature as a Fresnel lens and a feature as a diffraction lens and thus an incident light beam is converged on the photo-detector 9 by using both of refraction and diffraction as shown by the light beam L0. Therefore, the lens thickness “t” can be made thinner in comparison with a conventional Fresnel lens which utilizes only refraction. Further, since light condensing ability is high, a distance between the condenser lens 1 and the photo-detector 9 can be shortened to 14.5 mm and thus an influence of reflection and the like to the photo-detector 9 can be reduced by the shortened distance as described above.

Further, since diffraction and refraction are used together, and the steps 30 are formed in a flat face in the innermost circular zone region 111. Therefore, since the lens thickness “t” can be made thinner, the dividing number can be reduced to 3 (three) when a Fresnel lens structure is adopted. Accordingly, reflection and the like of a light beam in the grooves 21 and 22 occurring at boundary portions of the divided lens faces 11, 12 and 13 is reduced by the reduced number of the grooves 21 and 22, and transmittance is improved.

Further, both of refracting power and diffracting power in the divided lens face 111 (diffraction lens face) have positive power and condensing power is enhanced by utilizing 3-rd order as an order of diffraction, and thus radius of curvature of the divided lens face 11 can be increased.

Further, the plurality of divided lens faces 11, 12 and 13 are provided with different aspherical surfaces from each other. In addition, the plurality of divided lens faces 11, 12 and 13 are designed in which, with respect to a light beam with a specified wavelength at the incidence angle “0°”, the focal points of the divided lens face 12 and the divided lens face 13 that are located on the outer peripheral side of the lens are positioned at a nearer side of the condenser lens 1 than that of the divided lens face 11 that is located at the center side of the lens. Therefore, a diameter of a spot on the photo-detector 9 can be reduced.

Further, since directions of the grooves 21 and 22 are substantially parallel to a refracting direction of a light beam, as described with reference to FIG. 1(c) and FIG. 2(c), light beams which are incident on the grooves 21 and 22 are prevented from irradiating toward the photo-detector side. Further, since angles of the grooves 21 and 22 are broad, machining to a die for manufacturing a lens is easy.

Further, the light emitting face 3 is formed in a simple flat face or a simple curved face and thus complicated machining is not required to form the light emitting face 3.

In addition, the minimum pitch of the step 30 is about 20 μm to the height “h” of the step 30 of about 4 μm, and a pitch of the step 30 is set to be 4.5 times or more of the height “h” of the step 30 and thus diffraction efficiency is high and transmittance can be improved.

In addition, in this embodiment, since the effective diameter “D” is in a circular shape of about 30 Φ, coma aberration occurring at corner parts when an effective lens face is formed in a rectangular shape does not occur. Therefore, coma aberration can be restrained in comparison with the case where the effective face is formed in a rectangular shape and thus a spot diameter can be made smaller.

Moreover, in the plurality of divided lens faces 11, 12 and 13 in this embodiment, the divided lens face 11 located on the center side of the lens is a diffraction lens face on which the steps 30 are formed and the divided lens faces 12 and 13 located on the outer peripheral side of the lens are a refractive lens face on which the steps 30 are not formed. Therefore, coma aberration can be restrained in comparison with the third embodiment and, as shown in FIG. 9 which shows a relationship between an incidence angle on the condenser lens 1 and spot shapes in respective distances from the focal position, a diameter of the spot can be made smaller.

Further, in this embodiment, as described with reference to FIG. 7, when a light beam with a specified wavelength is incident at the incidence angle of “0°”, a focal position of the condenser lens 1 is located at a farther position than the photo-detector 9 seen from the condenser lens 1 and, in which focal positions of the divided lens faces 12 and 13 which are located at the outer peripheral side in the condenser lens 1 are nearer to the photo-detector 9 than that of the divided lens face 11 (circular zone regions 111, 112, 113 and 114) which is located at the center side. Therefore, balance of the diameter of a spot can be secured in the range of an incidence angle to the condenser lens 1.

In this embodiment, when a range of incidence angle is set to be ±θ°, the “θ” is set to be as follows;

θ=±7°

As shown in FIG. 9 which shows a relationship between an incidence angle and a spot area on the photo-detector when converged on the photo-detector 9 through the condenser lens 1 in this embodiment, a spot area at an incidence angle of 7° can be restrained to two-times or less of the spot area at the incidence angle of 0°. In other words, according to this embodiment, results of an incident angle and a longitudinal dimension and a transversal dimension of a spot are shown as follows.

| Incident | Transversal | Longitudinal | Area |
|---|---|---|---|
| angle (°) | dimension (mm) | dimension (mm) | (mm²) |
| 0 | 0.5 | 0.5 | 0.25 |
| 1 | 0.5 | 0.5 | 0.25 |
| 3 | 0.5 | 0.5 | 0.25 |
| 4 | 0.5 | 0.5 | 0.25 |
| 5 | 0.5 | 0.6 | 0.30 |
| 6 | 0.5 | 0.8 | 0.40 |
| 7 | 0.3 | 1.0 | 0.3 |
| 8 | 0.5 | 1.0 | 0.5 |
| 9 | 0.7 | 0.7 | 0.49 |

Accordingly, in this embodiment, the diameter of a spot is smaller in the entire range of an incidence angle even in comparison with the third embodiment and satisfies 0.5 mm² that is a tolerance of a spot area when a multi-divided photo-detector having a high resolution power is used. Therefore, even when a multi-divided photo-detector having a high resolution power is used as a photo-detector, a spot can be formed on an optical detection divided faces.

When the condenser lens 1 in this embodiment is used in an optical scanning device with a range of incidence angle of ±9°, in the case where the incidence angle is 7° or more, shading is occurred by an area of the photo-detector 9 and, as shown in FIG. 8, its appearance is reduced. In this case, when 0.5 mm² that is a tolerance of a spot area is satisfied, a multi-divided photo-detector with a high degree of resolution can be used as a photo-detector 9.

In the embodiments described above, a condenser lens is described which is used for converging a light beam of a scanning light beam that is emitted from a beam scanning device and reflected by an object to be irradiated. However, the present invention is not limited to the above-mentioned application and may be applied to a condenser lens for another application which is required to be a larger area and made thinner.

Further, in the embodiments described above, a condenser lens is described in which the grooves 21, 22 and 23, the divided lens faces 11, 12, 13 and 14 and the steps 30 are formed in a concentrically circular manner. However, the present invention may be applied to a toric lens and a cylindrical lens and, when the present invention is applied to a cylindrical lens, the grooves and the steps are formed to be parallel to an axial line of the cylindrical lens.

As described above, the condenser lens in accordance with the present invention is provided with both of a feature as a Fresnel lens and a feature as a diffraction lens and both of refraction and diffraction are utilized. Therefore, thickness can be easily made thinner in comparison with a conventional Fresnel lens which utilizes only refraction. Further, since a dividing number can be reduced, reflection and the like of a light beam at the groove which occurs at a boundary portion of the divided lens faces is reduced and thus transmittance is improved. Accordingly, improvement of detection sensitivity and miniaturization can be obtained in an optical scanning device.

It is understood that the present invention may be embodied with various changes, modifications and improvements that may occur to a person skilled in the art without departing from the spirit or scope of the invention defined in the appended claims.

1. A condenser lens comprising a plurality of divided lens faces which is formed in a Fresnel lens shape with grooves on at least one of a light incidence face and a light emitting face;
wherein the plurality of divided lens faces includes a diffraction lens face on which a plurality of steps is formed.

2. The condenser lens according to claim 1, wherein the grooves, the divided lens faces and the steps are formed in a concentrically circular manner.

3. The condenser lens according to claim 2, wherein when an order of diffraction of the divided lens face in a case where the steps are not formed is 0 (zero)-order, an order of diffraction of the divided lens face which is located on a center side of the lens is smaller than an order of diffraction of the divided lens face which is located on an outer peripheral side of the lens.

4. The condenser lens according to claim 2, wherein the divided lens face which is located on a center side of the lens is a refractive lens face which is not formed with the step, and the divided lens face which is located on an outer peripheral side of the lens is the diffraction lens face which is formed with the steps.

5. The condenser lens according to claim 2, wherein all of the plurality of divided lens faces are the diffraction lens faces where the steps are formed.

6. The condenser lens according to claim 5, wherein when an order of diffraction of the divided lens face in a case where the steps are not formed is 0 (zero)-order, an order of diffraction of the divided lens face which is located on a center side of the lens is smaller than an order of diffraction of the divided lens face which is located on an outer peripheral side of the lens.

7. The condenser lens according to claim 5, wherein when an order of diffraction of the divided lens face in a case where the steps are not formed is 0 (zero)-order, an order of diffraction of the divided lens face which is located on a center side of the lens is larger than or equal to an order of diffraction of the divided lens face which is located on an outer peripheral side of the lens.

8. The condenser lens according to claim 2, wherein when an order of diffraction of the divided lens face in a case where the steps are not formed is 0 (zero)-order, an order of diffraction of the divided lens face which is located on a center side of the lens is larger than or equal to an order of diffraction of the divided lens face which is located on an outer peripheral side of the lens.

9. The condenser lens according to claim 2, wherein the divided lens face which is located on a center side of the lens is the diffraction lens face which is formed with the steps, and the divided lens face which is located on an outer peripheral side of the lens is a refractive lens face which is not formed with the step.

10. The condenser lens according to claim 2, wherein the divided lens face which is located on at least innermost center side of the lens is the diffraction lens face which is formed with the steps and, in a center region of the diffraction lens face, the step is formed in a flat face.

11. The condenser lens according to claim 2, wherein when a range of an incidence angle is set to be ±θ°, a spot area at an incidence angle of θ° is 2 (two) times or less of a spot area at an incidence angle of 0 (zero)°.

12. The condenser lens according to claim 2, wherein refracting power and diffracting power in the diffraction lens face have positive power.

13. The condenser lens according to claim 2, wherein the plurality of divided lens faces is provided with different lens shape from each other.

14. The condenser lens according to claim 13, wherein the plurality of divided lens faces is provided with different aspherical surface shape from each other.

15. The condenser lens according to claim 14, wherein the plurality of divided lens faces is provided with a single focal point to a light beam with a specified wavelength.

16. The condenser lens according to claim 13, wherein when the light beam with the specified wavelength is incident at an incidence angle of 0 (zero)°, a focal point of the divided lens face which is located on an outer peripheral side of the lens is nearer to the condenser lens than a focal point of the divided lens face which is located on a center side of the lens.

17. The condenser lens according to claim 2, wherein a direction of the groove which is located at a boundary region between the divided lens faces is substantially parallel to a refracting direction of a light beam.

18. The condenser lens according to claim 2, wherein lens material is resin.

19. The condenser lens according to claim 2, wherein the plurality of divided lens faces is formed on the light incidence face and the light emitting face is formed in a simple flat face or a simple curved surface.

20. The condenser lens according to claim 2, wherein a pitch of the step is set to be 4.5 times or more of a step height which is defined as the following expression;
mλ/(n−1)
wherein “m” denotes order of diffraction, “X” denotes wavelength, and “n” denotes index of refraction of a lens material.

21. The condenser lens according to claim 2, wherein a shape of an effective diameter is circular.

22. An optical scanning device comprising:
the condensing lens set forth in claim 1 for converging a reflected light beam of a scanning light beam, which is reflected by an object to be irradiated, on the photo-detector.

23. The optical scanning device according to claim 22, wherein a focal position of the condenser lens is located at a farther position than the photo-detector seen from the condenser lens when a light beam with a specified wavelength is incident at the incidence angle of “0°”, and a focal position of the divided lens face which is located at an outer peripheral side of the condenser lens is nearer to the photo-detector than a focal position of the divided lens face which is located at a center side of the lens.
